(19) United States
(12) Patent Application Publication
(10) Pub. No.: US 2010/0040785 A1
(43) Pub. Date: Feb. 18, 2010

(54) Method For Dry-Cleaning Leather

(75) Inventor: Frank-Peter Lang, Hattersheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/440,554

(22) PCT Filed: Sep. 4, 2007
(86) PCT No.: PCT/EP07/07687

§ 371 Date: Mar. 24, 2009

(30) Foreign Application Priority Data
Sep. 9, 2006 (DE) 10 2006 042 449.2
Sep. 4, 2007 (EP) PCT/EP2007/007687

(51) Int. Cl. B05D 3/10; C11D 3/20

(52) U.S. Cl. 427/323; 510/275

(57) ABSTRACT

The invention relates to a method for dry-cleaning leather, characterized by treating the leather with compound (I),

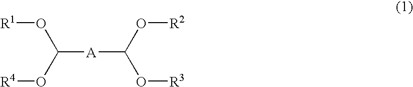

wherein R¹, R², R³ and R⁴ are defined as in the description. The preferred solvent is tetraethoxyethane

Unlike textiles, which are substantially cleaned with water and laundry detergents and which are essentially only cleaned with organic solvents in the case of particularly sensitive material or in the case of stubborn soiling, leather is dry-cleaned almost exclusively.

Halogenated hydrocarbons are still being used as cleaning medium for leather. They include the hydrochlorocarbons trichloroethene, 1,1,1-tri-chloroethane and dichloromethane which are no longer permissible in Germany for example. Similarly, the chlorofluorocarbons (CFCs), which used to be widely used in dry cleaning, are no longer permitted for this use in many countries.

The solvent which is still being widely used is tetrachloroethene (perchloroethylene, perchlorethylene, perc, PER). Tetrachloroethene is a volatile chlorinated hydrocarbon which, by virtue of its fat-dissolving ability, has come to be widely used in industry as a solvent/cleaner, including in the cleaning of leather. The disadvantages of PER are in particular its potential carcinogenic effect on humans; its high volatility; its ready solubility in fat-containing foods; and its strongly water-endangering properties. PER is classified as dangerous in the EU's Black List and Germany's Haz Chem regulations.

Dry cleaning solvents, in particular perchloroethylene, pose dangers if allowed to pass into the environment.

Potential sources of emissions are the cleaning machine, the drying air, the contact water, the distillation sludge, the leather if inadequately dried and/or due to solvent retention, as well as accidents.

The control of the emission paths for organic solvents in the dry cleaning sector varies between different countries according to their environmental legislation and the degree to which their laws are observed and policed.

In Germany, dry cleaning operators and machine manufacturers have to meet a multiplicity of requirements to limit perchloroethylene emissions, such as maximum permissible values for PER emissions in the exit gas, in the drum region and in adjacent rooms, which entails a substantial engineering commitment. However, irrespectively of the extent to which PER emissions are policed in dry cleaning establishments, appreciable amounts of PER may be retained in leather so that the emission of solvents by the leather is important as well. In the case of PER, this can lead to indoor air exposures suffered by the consumer far away from the leather dry-cleaning establishment.

The chlorofluorocarbons (CFCs) mentioned at the beginning, which are now no longer permitted in dry cleaning in most countries, made extremely low drying temperatures and, because of the high volatility, also short drying times and hence low mechanical stress on the leather articles possible. Irreversible damage could thus reliably be avoided. Halogen-free hydrocarbon solvents (HCS) have now been used for some time as technical alternatives to the banned CFCs as well as to the widely used PER. Originally, HCS solvents were only considered as a replacement for CFCs with regard to the cleaning of particularly sensitive materials.

The HCS solvents are straight-chain aliphatics or mixtures of straight-chain, branched and cyclic aliphatics having 10 to 14 carbon atoms. Their higher boiling range from about 180 to 210° C. makes them distinctive from the petroleum fractions formerly likewise used in dry cleaning, or from perchloroethylene which has a boiling point of only 121° C. HCS solvents are widely used in dry cleaning in the US and Japan, as well as in other countries.

However, one disadvantage with the use of HCS is that, as a consequence of the low vapor pressures, the drying temperatures have to be raised and/or the drying times distinctly extended. This imposes a distinctly greater thermal and mechanical stress on sensitive articles, which shortens their useful consumer lives.

In addition, the energy requirements to distill and recycle HCS are distinctly higher compared with PER.

There is accordingly still a need for organic solvents which not only possess good cleaning power, but also can be deemed superior to the prior art in the eyes of toxicologists and ecologists and because of their physical-chemical properties.

Moreover, they should be substantially usable in the cleaning processes which the prior art employs for perchloroethylene (PER) and the hydrocarbon solvents (HCS).

The PER cleaning process consists of three stages:
1) The actual cleaning operation in a solvent bath which further includes some water and cleaning boosters (comprising surfactants, cosolvents and other components).
2) The drying with heated air and the recovery of the solvent by condensation and adsorption.
3) The solvent regeneration through filtration and distillation, or desorption.

The cleaning with HCS in principle involves the same stages as the PER cleaning process. The cleaning techniques on offer from various producers differ by separation of cleaning and drying (reloading technique), cleaning and drying being integrated in one machine (closed circuit) and also by inertization during cleaning and drying (nitrogen, combination of fresh air and circulating air or vacuum).

The following requirements should be at least substantially met by organic solvents contemplated as an alternative to perchloroethylene and/or to the hydrocarbon solvents:

Good cleaning power in general and good ability to detach water-soluble or water-swellable soil and pigmentary soil, if appropriate through the addition of water-surfactant combinations (cleaning boosters) to the solvent; very good dissolving capacity for fats and oils; good dispersing capacity and sufficient dispersion stability for pigmentary soil to avoid soil redeposition; very little if any influencing of the leather (dyes and finishes, for example Napalan®), for example only limited swelling, negligible changes to the thermo-mechanical properties, no detachment of dyes, finishes, hotmelt adhesives, etc. (nor in the course of drying); gentle cleaning of plastics, which are used for example as buttons and appliques; very low retention in the leather; no solvent odor in the cleaned articles; a high volatility to facilitate drying and recovery; a sufficiently high flashpoint; little if any corrosivity toward metals and other materials of the cleaning and drying machines, not even in the presence of water; only minimal if any decomposition under cleaning and distillation conditions, i.e., in the presence of soil and at higher temperatures; low viscosity to facilitate soil detachment and for better mechanical removal of the solvent by centrifugation; low solubility in water but a certain amount of solvent power for water (if appropriate through the addition of surfactants and other solubilizers); dissolving power for so-called cleaning boosters (comprising for example nonionic, anionic, cationic, amphoteric surfactants, other solvents, for example (2-methoxymethylethoxy)propanol, specific salts, bleaching agents, disinfectants, antistats and other additives); good dissolving power for refatting substances, such as leather oils, leather fats, leather fatliquors, which are added to the solvent during the cleaning operation to avoid excessive defatting and embrittlement of the leather; formation of stable water-surfactant emulsions in the solvent; compliance with the maximum processing values mandated by the care-labeling scheme; and also low toxicity to humans and the environment.

The present invention has for its object to provide organic solvents which achieve the aforementioned leather dry cleaning requirements better than prior art solvents and which possess a better toxicological and ecological profile.

It has now been found that, surprisingly, compounds of the formula (1) possess superior cleaning capacity for leather and also de-fat the leather less strongly and are judged as toxicologically and ecologically substantially more favorable than perchloroethylene and hydrocarbon solvents and in addition also fulfill the other aforementioned requirements and thus are very useful as dry cleaning medium for leather.

The present invention accordingly provides for the use of compounds of the formula (1) as an organic cleaning agent and solvent in the dry cleaning of leather

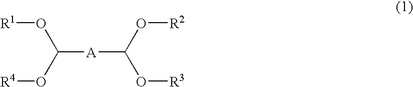

where

A is (CH₂)ₐ or phenylene,

R¹, R², R³ and R⁴ identically or independently are C₁ to C₁₃-n- and/or iso-alkyl,
C₅- or C₆-cycloalkyl, phenyl-C₁-C₄-alkyl, C₁-C₉-alkylphenyl or phenyl,

and a is an integer from 0 to 6.

Preferably R¹, R², R³ and R⁴ identically or independently are C₁ to C₆-n- and/or iso-alkyl, cyclohexyl, benzyl, C₁-C₉-alkylphenyl or phenyl and a is preferably from 0 to 2.

More preferably, R¹, R², R³ and R⁴ identically or independently are C₂ to C₄-n- and/or iso-alkyl and a is preferably 0.

Examples of the R¹ to R⁴ radicals are for example: methyl, ethyl, n-propyl, isopropyl, n-butyl, isobutyl, sec-butyl, tert-butyl, n-amyl, isoamyl, tert-amyl, neopentyl, cyclopentyl, n-hexyl, isohexyl, cyclohexyl, octyl, decyl, isotridecyl, phenyl, benzyl, phenylethyl, nonylphenyl.

The compounds of the general formula (1) are acetals. Acetals are generally obtained by reaction of aldehydes with 2 mol of an alcohol per carbonyl group in the presence of catalysts, such as dry hydrogen chloride for example.

Dialdehydes have to be used to synthesize compounds of the formula (1). Preferred dialdehydes for synthesizing compounds of the formula (1) are glyoxal, malonaldehyde (1,3-propanedial, 1,3-propanedialdehyde), 1,4-butanedial and terephthalaldehyde.

A greatly preferred dialdehyde is glyoxal, which leads to compounds of the formula (1) where a=0. A particularly preferred compound for the purpose described is tetraethoxyethane (2) from Clariant

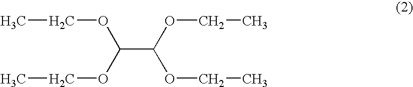

Compounds of the formula (1), preferably tetraethoxyethane (=glyoxal bisdiethyl acetal) of the formula (2) can be utilized at various stages of the dry cleaning process. These include in particular the use as a dissolving and cleaning agent in the basic cleaning operation. Here, the compounds of the formula (1) can wholly replace the cleaning agents perchloro-ethylene, hydrocarbons and also other solvents.

The use of the solvents of the formula (1) can be effected in accordance with existing processes in so-called PER machines or in HCS machines (for example from Satec).

Representative processing conditions for using the compounds of the formula (1) are indicated by the hereinbelow described processing conditions for PER and HCS machines.

| Process parameter | PER machine | | HCS machine | |
|---|---|---|---|---|
| Speeds | | | | |
| Cleaning | 35 | rpm | 30-40 | rpm |
| Whizzing | 380 | rpm | 700-800 | rpm |
| g-factor (whizzing) | 77 | | 330 | |
| Load | 18 | kg | 18 | kg |
| Liquor ratio | | | | |
| Low level | 1:1.7 | kg/l | 1:3.9 | kg/l |
| High level | 1:3.9 | kg/l | 1:6.7 | kg/l |
| Whirlbath | — | | 1:6.7 | kg/l |
| Filter | Centrifugal filters | | Cartridges | |
| Drying temperature | 60° | C. | 70° | C. |

| | | |
|---|---|---|
| Drying process | Completion of drying process | Nitrogen inertization |
| | at in-drum PER content of <2 | Heating unlocked at |
| | g/m³ at fabric temperature of | oxygen content <9% |
| | at least 35° C. | |
| Solvent distillation | Under atmospheric pressure | max. −70 cm Hg |

Process modifications or modifications to the cleaning machines may be necessary, depending on the physical-chemical properties of specific compounds of the formula (1).

For instance, different boiling points, due to different R¹ to R⁴ radicals and/or different a values, may necessitate different drying temperatures and, for example, variations in the distillation conditions to recover the solvent (pressure, temperature).

Flashpoints other than those of the HCS solvents used may also necessitate safety-engineering modifications, for example through the type of inertization (residual oxygen contents).

More particularly, the organic R radicals in the solvents of the formula I can be varied to control the dissolving power for apolar substances (other solvents, fats, oils) and also for polar substances and solvents (including water).

Different retentions and viscosities may also for example necessitate different g factors for whizzing off the solvent. In commercial practice, HCS machines utilize higher g factors than PER machines.

Further factors which may be altered/optimized through the use of solvents of the formula (1) include, for example, cleaning time, liquor ratio, reversing rhythm, load level, type and amount of cleaning booster used, type and amount of the necessary refatting agent (leather oils, leather fatliquors), application of a whirlbath through injection of an air-solvent mixture for more gentle cleaning.

All such modifications to the conventional process of dry cleaning which are the result of using the novel solvents of the formula (1) are easily determined by one of ordinary skill in the art through preliminary tests.

Dry cleaning processes are further distinguished between the one bath process and the two bath process. Standard work is generally cleaned in the two bath process by employing a short liquor ratio in the first bath and a longer liquor ratio in the second bath. The first bath serves to detach the main soil. Solvents of the formula (1) can be used in the one bath process and in the two bath process.

But in principle it is also possible to combine cleaning agents of the formula (1) with perchloroethylene, hydrocarbons or other solvents and thus partially replace the traditional solvents.

As well as being used as “main cleaning agent” (for the basic cleaning operation), compounds of the formula (1) can also be utilized in spotting agents, in cleaning activators or in cleaning boosters. Spotting agents are used for localized spot removal in industrial cleaning. The following groups of spotting agents are distinguished:
1) Brushing agents are used for the prespotting of large soiled areas. They are applied neat, with a soft brush or by spraying, to the badly soiled areas prior to the basic cleaning operation.
2) Dedicated spotting agents are used to treat intensive specific stains. They are applied directly to the stain, and allowed to act thereon, prior to the basic cleaning operation.
3) Postspotting agents are used after the basic cleaning operation, to remove any stains remaining.

Cleaning activators are used to remove spots and may also comprise odor absorbents for example. They are applied in the pretreatment bath and, being soil dissolvers, obviate any brushing.

Cleaning boosters, being added to the organic solvent used as cleaning medium, are intended to enhance the cleaning performance and, more particularly, also to effect the detachment of water-soluble or water-swellable soils which are only sparingly soluble, if at all, in the organic solvent. Examples of such water-soluble compounds include gritting salt (NaCl in high purity or else in mixture with CaCl₂ or MgCl₂ sols) as used in winter to deice sidewalks and streets. They shall further remove insoluble, pigmentary soil and exhibit a pigment-dispersing capacity and so inhibit the redeposition of detached particulate soil. They further serve to improve fabric hand.

Cleaning boosters typically comprise surfactants (in particular anionic, nonionic, amphoteric surfactants or else cationic surfactants), solvents, antistats, softeners or hand-improving additives and, if appropriate, specialty adds such as disinfectants and bleaching agents. Furthermore, the cleaning booster can be used to introduce small amounts of water into the cleaning bath that is emulsified into the organic solvents with the surfactants.

The cleaning-agent bath, i.e., the solvent of the formula (1) used for the basic cleaning operation, the spotting agents, the cleaning activators and the cleaning boosters comprising solvent of the formula (1) may comprise the following further soil release enhancers.

### Surfactants

Surfactants which may be used in addition to or in the cleaning agents of the formula (1), for example in tetramethoxyethane (2), are:

### Anionic Surfactants

Useful anionic surfactants include sulfates, sulfonates, carboxylates, phosphates and mixtures thereof. Suitable cations are alkali metals, for example sodium or potassium, or alkaline earth metals, for example calcium or magnesium, and also ammonium, substituted ammonium compounds, including mono-, di- or triethanolammonium cations, and mixtures thereof.

The following types of anionic surfactants are particularly preferred: alkyl ester sulfonates, alkyl sulfates, alkyl ether sulfates, alkylbenzenesulfonates, alkanesulfonates and soaps as described in what follows.

Alkyl ester sulfonates include linear esters of C₈-C₂₂-carboxylic acids (i.e., fatty acids) which are sulfonated with gaseous SO₃. Suitable starting materials are natural fats, such as tallow, coco oil and palm oil for example. But the carboxylic acids may also be synthetic in nature. Preferred alkyl ester sulfonates are compounds of the formula

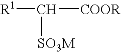

where R¹ is a C₈-C₂₀-hydrocarbyl radical, preferably alkyl, and R is a C₁-C_{C}₆-hydrocarbyl radical, preferably alkyl. M represents a cation which forms a water-soluble salt with the alkyl ester sulfonate. Suitable cations are sodium, potassium, lithium or ammonium cations, such as monoethanolamine, diethanolamine and triethanolamine. Preferably, R¹ is C₁₀-C₁₆-alkyl and R is methyl, ethyl or isopropyl. Particular preference is given to methyl ester sulfonates wherein R¹ is C₁₀-C₁₆-alkyl.

Alkyl sulfates are salts or acids of the formula ROSO₃M, where R is a C₁₀-C₂₄-hydrocarbyl radical, preferably an alkyl or hydroxyalkyl radical having a C₁₀-C₂₀-alkyl component, more preferably a C₁₂-C₁₈ alkyl or hydroxyalkyl radical.

M is hydrogen or a cation, for example an alkali metal cation (examples being sodium, potassium, lithium) or ammonium or substituted ammonium, for example methyl—, dimethyl- and trimethylammonium cations and quaternary ammonium cations such as tetramethylammonium and dimethylpiperidinium cations and quaternary ammonium cations derived from alkylamines, such as ethylamine, diethylamine, triethylamine and mixtures thereof.

Alkyl ether sulfates are salts or acids of the formula RO(A)ₘ SO₃M, where R is an unsubstituted C₁₀-C₂₄-alkyl or hydroxyalkyl radical, preferably a C₁₂-C₂₀ alkyl or hydroxyalkyl radical, more preferably a C₁₂-C₁₈-alkyl or hydroxyalkyl radical. A is an ethoxy or propoxy unit, m is a number greater than 0, preferably between about 0.5 and about 6, and more preferably between about 0.5 and about 3, and M is a hydrogen atom or a cation, for example sodium, potassium, lithium, calcium, magnesium, ammonium or a substituted ammonium cation.

Specific examples of substituted ammonium cations are methyl-, dimethyl- and trimethylammonium and quaternary ammonium cations such as tetramethylammonium and dimethylpiperidinium cations and also those derived from alkylamines, such as ethylamine, diethylamine, triethylamine or mixtures thereof. Examples which may be mentioned are C₁₂- to C₁₈- fatty alcohol ether sulfates wherein the EO content is 1, 2, 2.5, 3 or 4 mol per mole of the fatty alcohol ether sulfate and wherein M is sodium or potassium.

The alkyl group in secondary alkanesulfonates may be either saturated or unsaturated, branched or linear and optionally hydroxyl substituted. The sulfo group may be situated on any position of the carbon chain, although the primary methyl groups at either end of the chain do not possess any sulfonate groups.

The preferred secondary alkanesulfonates comprise linear alkyl chains having about 9 to 25 carbon atoms, preferably about 10 to about 20 carbon atoms and more preferably about 13 to 17 carbon atoms. The cation is for example sodium, potassium, ammonium, mono-, di- or triethanolammonium, calcium or magnesium, or mixtures thereof. Sodium is the preferred cation.

Secondary alkanesulfonate is obtainable under the trade name of Hostapur SAS (from Clariant).

As well as secondary alkanesulfonates primary alkanesulfonates can likewise be used in the washing compositions of the present invention. The preferred alkyl chains and cations are as for the secondary alkanesulfonates.

Useful anionic surfactants further include alkenyl- or alkylbenzenesulfonates. The alkenyl or alkyl group may be branched or linear and optionally hydroxyl substituted. The preferred alkylbenzenesulfonates comprise linear alkyl chains having about 9 to 25 carbon atoms and preferably from about 10 to about 13 carbon atoms; the cation is sodium, potassium, ammonium, mono-, di- or triethanolammonium, calcium or magnesium and mixtures thereof. Magnesium is the preferred cation for mild surfactant systems, whereas sodium is the preferred cation for standard applications. The same applies to alkenylbenzenesulfonates.

The term “anionic surfactants” also comprehends olefinsulfonates, which are obtained by sulfonation of C₈-C₂₄-olefins and preferably C₁₄-C₁₆-α-olefins with sulfur trioxide and subsequent neutralization. Their method of production is such that these olefinsulfonates may comprise minor amounts of hydroxyalkanesulfonates and alkanedisulfonates.

Preferred anionic surfactants further include carboxylates, examples being fatty acid soaps and comparable surfactants. The soaps may be saturated or unsaturated and may comprise various substituents, such as hydroxyl groups or α-sulfonate groups. Preference is given to linear saturated or unsaturated hydrocarbyl radicals as a hydrophobic moiety having about 6 to about 30 and preferably about 10 to about 18 carbon atoms.

Useful anionic surfactants further include salts of acylamino carboxylic acids, acyl sarcosinates formed by reaction of fatty acid chlorides with sodium sarcosinate in an alkaline medium; fatty acid-protein condensation products obtained by reaction of fatty acid chlorides with oligopeptides; salts of alkylsulfamido carboxylic acids; salts of alkyl and alkylaryl ether carboxylic acids; sulfonated polycarboxylic acids; alkyl and alkenyl glycerol sulfates such as oleyl glycerol sulfates, alkylphenol ether sulfates, alkyl phosphates, alkyl ether phosphates, isethionates, such as acyl isethionates, N-acyltaurides, alkyl succinates, sulfosuccinates, monoesters of sulfosuccinates (particularly saturated and unsaturated C₁₂-C₁₈ monoesters) and diesters of sulfosuccinates (particularly saturated and unsaturated C₁₂-C₁₈ diesters), acyl sarcosinates, sulfates of alkylpolysaccharides such as sulfates of alkylpolyglycosides, branched primary alkyl sulfates and alkyl polyethoxy carboxylates such as those of the formula RO(CH₂CH₂)ₖCH₂COO⁻M⁺, where R is C₈ to C₂₂ alkyl, k is from 0 to 10 and M is a cation.

### Nonionic Surfactants

Condensation products of aliphatic alcohols with about 1 to about 25 mol of ethylene oxide.

The alkyl chain of the aliphatic alcohols may be linear or branched, primary or secondary, and comprises in general from about 8 to about 22 carbon atoms. Particular preference is given to the condensation products of C₁₀- to C₂₀-alcohols with about 2 to about 18 mol of ethylene oxide per mole of alcohol. The alkyl chain may be saturated or else unsaturated. The alcohol ethoxylates may comprise the ethylene oxide in a narrow homolog distribution (“narrow range ethoxylates”) or in a broad homolog distribution (“broad range ethoxylates”). This class of products includes for example the Genapol® brands (from Clariant).

Condensation products of ethylene oxide with a hydrophobic base, formed by condensation of propylene oxide with propylene glycol. The hydrophobic part of these compounds preferably has a molecular weight between about 1500 and about 1800. The addition of ethylene oxide onto this hydrophobic part leads to improved solubility in water. The product is liquid up to a polyoxyethylene content of about 50% of the overall weight of the condensation product, which corresponds to a condensation with up to about 40 mol of ethylene oxide. Commercially available examples of this class of products are the ®Genapol PF brands (from Clariant).

Condensation products of ethylene oxide with a reaction product of propylene oxide and ethylenediamine.

The hydrophobic unit of these compounds consists of the reaction product of ethylenediamine with excess propylene oxide and generally has a molecular weight in the range of about 2500 to 3000. Ethylene oxide is added onto this hydrophobic unit up to a level of about 40% to about 80% by weight of polyoxyethylene and a molecular weight of about 5000 to 11 000. Commercially available examples of this class of compounds are the ®Tetronic brands from BASF and the ®Genapol PN brands from Clariant GmbH.

### Semipolar Nonionic Surfactants

This category of nonionic compounds comprises water-soluble amine oxides, water-soluble phosphine oxides and water-soluble sulfoxides, each having an alkyl radical of about 10 to about 18 carbon atoms. Semipolar nonionic surfactants further include amine oxides of the formula

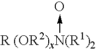

where R is an alkyl, hydroxyalkyl or alkylphenol group having a chain length of about 8 to about 22 carbon atoms, R² is an alkylene or hydroxyalkylene group having about 2 to 3 carbon atoms or mixtures thereof, every R¹ radical is an alkyl or hydroxyalkyl group having about 1 to about 3 carbon atoms or a polyethylene oxide group having about 1 to about 3 ethylene oxide units and x is from 0 to about 10. The R¹ groups may be joined together via an oxygen or nitrogen atom and thus form a ring. Amine oxides of this kind are particularly C₁₀-C₁₈-alkyldimethylamine oxides and C₈-C₁₂-alkoxyethyldihydroxyethylamine oxides.

### Fatty Acid Amides

Fatty acid amides have the formula

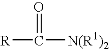

where R is an alkyl group having about 7 to about 21 and preferably about 9 to about 17 carbon atoms and every R¹ radical is hydrogen, C₁-C₄-alkyl, C₁-C₄-hydroxyalkyl or (C₂H₄O)ₓH, where x varies from about 1 to about 3. C₈-C₂₀ amides, monoethanolamides, diethanolamides and isopropanolamides are preferred.

Useful nonionic surfactants further include alkyl and alkenyl oligoglycosides and also fatty acid polyglycol esters or fatty amine polyglycol esters each having 8 to 20 and preferably 12 to 18 carbon atoms in the fatty alkyl moiety, alkoxylated triglycamides, mixed ethers or mixed formyls, alkyl oligoglycosides, alkenyl oligoglycosides, fatty acid N-alkyl glucamides, phosphine oxides, dialkyl sulfoxides and protein hydrolyzates.

Polyethylene, polypropylene and polybutylene oxide condensates of alkylphenols.

These compounds comprise the condensation products of alkylphenols having a C₆- to C₂₀-alkyl group, which may be either linear or branched, with alkene oxides. Preference is given to compounds having about 5 to 25 mol of alkene oxide per mole of alkylphenol. Commercially available surfactants of this type are for example the ®Arkopal N brands (from Clariant). These surfactants are referred to as alkylphenol alkoxylates, an example being alkylphenol ethoxylates.

### Zwitterionic Surfactants

Typical examples of amphoteric or zwitterionic surfactants are alkyl betaines, alkylamide betaines, aminopropionates, aminoglycinates, or amphoteric imidazolinium compounds of the formula

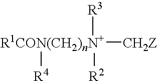

where R¹ denotes C₈-C₂₂-alkyl or -alkenyl, R³ denotes hydrogen or CH₂CO₂M, R³ denotes CH₂CH₂OH or CH₂CH₂OCH₂CH₂CO₂M, R⁴ denotes hydrogen, CH₂CH₂OH or CH₂CH₂COOM, Z denotes CO₂M or CH₂CO₂M, n denotes 2 or 3, preferably 2, M denotes hydrogen or a cation such as alkali metal, alkaline earth metal, ammonium or alkanolammonium. Preferred amphoteric surfactants of this formula are monocarboxylates and dicarboxylates. Examples thereof are cocoamphocarboxypropionate, cocoamido carboxy propionic acid, cocoamphocarboxyglycinate (or else referred to as cocoamphodiacetate) and cocoamphoacetate.

Preferred amphoteric surfactants further include alkyl dimethyl betaines (®Genagen LAB/Clariant GmbH) and alkyl dipolyethoxy betaines having an alkyl radical of about 8 to about 22 carbon atoms, which may be linear or branched, preferably 8 to 18 carbon atoms and more preferably having about 12 to about 18 carbon atoms.

Useful cationic surfactants include substituted or unsubstituted straight-chain or branched quaternary ammonium salts of the type R¹N(CH₃)₃⁺X⁻, R¹R²N(CH₃)₂⁺X⁻, R¹R²R³N(CH₃)⁺X⁻ or R¹R²R³R⁴N⁺X⁻. The R¹, R², R³ and R⁴ radicals may preferably independently be unsubstituted alkyl having a chain length of between 8 and 24 carbon atoms and especially between 10 and 18 carbon atoms, hydroxyalkyl having about 1 to about 4 carbon atoms, phenyl, C₂- to C₁₈-alkenyl such as, for example, tallow alkyl or oleyl, C₇- to C₂₋₄-aralkyl, (C₂H₄O)ₓH, where x is from about 1 to about 3, or else alkyl radicals comprising one or more ester groups, or cyclic quaternary ammonium salts. X is a suitable anion.

As well as surfactants, further materials may be present: odor absorbents, deodorants, scents, antistats, microbicides such as bactericides and fungicides, preservatives, solubilizers, fiber regenerants, finishes, emulsifiers, enzymes, impregnants and also water in small amounts.

When compounds of the formula (1) are used for leather cleaning, agents for refatting the leather can further be added to the cleaning-agent bath. These agents include leather oils, leather fats/leather fatliquors, oil-in-water emulsions. These are necessary to retain the performance characteristics of the leather and to protect it against embrittlement.

In addition, the cleaned leather articles can, after cleaning, be aftertreated with oil-in-water emulsions. This can be done for example by spraying with such emulsions, and the leather article thoroughly moistened with the emulsion is dried in a tumbler with hot air for example. After the water fraction has evaporated, the oil remains behind in the leather and thus preserves its suppleness and ensures a soft hand or feel. The aftertreatment with an oil-in-water emulsion is generally necessary despite the addition of refatting agents to the cleaning-agent bath. Alternatively, the leathers can also be treated with solvent-based impregnants. These impregnants may likewise comprise compounds of the formula (1) as solvents.

### EXAMPLES

The hereinbelow described investigations were carried out using tetraethoxyethane (TEE) of the formula (2) as an example of a solvent of the formula (1).

The following were utilized as references:

tetrachloroethene (=perchloroethylene=PER)
C₁₀₋₁₃ isoalkanes (=hydrocarbon solvent=HCS)

### Example 1

The power to remove a vegetable oil stain from tanned, undyed goat suede leather was investigated. To this end, the leather specimens were stained with vegetable oil colored with the fat-soluble dye Sudan Red. The leather specimens were then washed with tetraethoxyethane and the reference solvents at room temperature in a Linitest laboratory washing machine. After the wash, they were dried and to quantify soil release the delta E values relative to the unstained leather were determined. The smaller the color difference delta E, the better the stain removal from the leather.

TABLE 1
Removal of vegetable oil by tetraethoxyethane
(TEE) compared with PER and HCS

| | delta E value to unstained leather | | |
|---|---|---|---|
| Goat suede leather | after cleaning with . . . | | |
| stained with | TEE | PER | HCS |
| Vegetable oil/Sudan | 0.5 | 0.9 | 1.5 |
| Red | | | |

### Example 2

The soil redeposition in tetraethoxyethane was investigated and compared with that of PER and HCS. To this end, clean, tanned, undyed goat suede leather was washed in the solvents and a dispersion of carbon black in olive oil was added to each solvent as soil ballast. After the wash, the leather specimens were dried and the soil deposited on them was quantified. This was done by determining the color shift delta E compared with clean unwashed fabric. The lower the delta E values, the lower the soil deposition which takes place in the respective solvent.

TABLE 2
Staining delta E of leather specimens by soil redeposition

| | Staining delta E of clean leather by soil | | |
|---|---|---|---|
| Goat suede leather | redeposition in . . . | | |
| stained with | TEE | PER | HCS |
| Carbon black/olive oil | 7.0 | 15.4 | 14.1 |

### Example 3

### Stability of Leather Dyeings

The stability of leather dyeings, i.e., color preservation, was investigated with dyed leather. To this end, a dyed leather specimen was washed with tetraethoxyethane and, for comparison, with the reference solvents. After 10 min, the dyed leather specimens were removed, dried and their color shift delta E relative to the unwashed leather specimens was determined. The lower the color shift delta E, the greater the benignness of the cleaning of the respective solvent for the dyed leather. Ideally, the delta E values are equal to zero.

TABLE 3
Color preservation of differently colored leathers after washing
with tetraethoxyethane for 10 min compared with PER and HCS

| | Color differences delta E after a 10 min wash in . . . | | |
|---|---|---|---|
| Dyed leather: | TEE | PER | HCS |
| Calf leather, brown | 3.1 | 5.9 | 6.4 |
| Sheep nappa, green | 1.7 | 2.0 | 1.4 |
| Sheep nappa, red | 3.9 | 6.8 | 4.4 |
| Sum total of test | 8.7 | 14.7 | 12.2 |
| leathers | | | |

1. A process for dry cleaning of leather, which comprises the step of treating the leather with a compound of the formula (1) 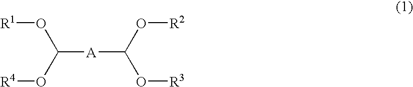
wherein
A is (CH₂)ₐ or phenylene,
R¹, R², R³ and R⁴ are identically or independently selected from the group consisting of: denote C₁ to C₁₃-n- and/or iso-alkyl, C₅- or C₆-cycloalkyl, phenyl-C₁-C₄-alkyl, C₁-C₉-alkylphenyl and phenyl, and a is an integer from 0 to 6.

2. The process according to claim 1 wherein the leather is treated with a compound of the formula (1) where R¹, R², R³ and R⁴ are identically or independently selected from the group consisting of: C₁ to C₆-n- and/or iso-alkyl, cyclohexyl, benzyl, C₁-C₈-alkylphenyl and phenyl, and a is an integer from 0 to 2.

3. The process according to claim 1 wherein the leather is treated with a compound of the formula (1) where R¹, R², R³ and R⁴ are identically or independently C₂ to C₄-n- and/or iso-alkyl and a is 0.

4. The process according to claim 1 wherein the leather is treated with a compound of the formula (1) where R¹, R², R³ and R⁴ identically are ethyl and a is 0.

5. The process according to claim 1 wherein the compound of the formula (1) is utilized in the basic cleaning operation.

6. The process according to claim 1 wherein the compound of the formula (1) is utilized as a constituent of a spotting agent, of a cleaning booster or of a cleaning activator.

7. The process according to claim 1 wherein the compound of the formula (1) is utilized in combination with anionic surfactants, nonionic surfactants, amphoteric surfactants, cationic surfactants, odor absorbents, deodorants, scents, antistats, microbicides such as bactericides and fungicides, preservatives, solubilizers, fiber regenerants, finishes, emulsifiers, leather oils, leather fats, leather fatliquors, oil-in-water emulsions, refatters, enzymes, impregnants and also water in small amounts.

8. The process according to claim 1 wherein the cleaned leather is aftertreated with an oil-in-water emulsion.

9. The process according to claim 1 wherein the cleaned leather is aftertreated with an impregnant comprising an organic solvent.

10. The process according to claim 1 wherein the cleaned leather is aftertreated with an impregnant comprising a compound of the formula (1).
